(19) United States
(12) Patent Application Publication
(10) Pub. No.: US 2024/0391368 A1
(43) Pub. Date: Nov. 28, 2024

(54) AIR CONDITIONING SYSTEM FOR A VEHICLE SEAT

(71) Applicant: GENTHERM GMBH, Odelzhausen (DE)

(72) Inventors: Ravi Philip, Windsor (CA); Denis Miron, Windsor (CA)

(21) Appl. No.: 17/921,399

(22) PCT Filed: Apr. 27, 2022
(86) PCT No.: PCT/IB2022/000238

§ 371 Date: Oct. 26, 2022

Related U.S. Application Data
(60) Provisional application No. 63/226,042, filed on Jul. 27, 2021.

(51) Int. Cl. B60N 2/56

(52) U.S. Cl. CPC B60N 2/56

(57) ABSTRACT

An air conditioning system for a vehicle seat that includes an air mover; and an air distributor in fluid communication with the air mover, the air distributor has a top layer, a bottom layer, and a spacer layer between the top layer and the bottom layer; the top layer has a first perimeter strip that extends around a perimeter of the top layer, the first perimeter strip extends around a ventilation aperture defined in the top layer, and the first perimeter strip is connected to the bottom layer.

### PRIORITY

This application claims priority to U.S. 63/226,042 filed on Jul. 27, 2021, the entirely of which is hereby incorporated by reference herein for all purposes.

### FIELD

These teachings relate generally to a ventilated vehicle seat, and more particularly to an air conditioning system for a ventilated vehicle seat that can be used in a variety of vehicle seat platforms and/or use with different vehicle seat cushion designs.

### BACKGROUND

Some vehicle seats include one or more features for improving occupant comfort. For example, some vehicle seats have an air conditioning system for moving air towards or away from an occupant of the vehicle seat.

Many air conditioning systems are designed or intended for a specific application or vehicle seat platform, where the seat cushion vent holes have a unique or specific size, shape, or pattern, are located in a specific region of the seat, and/or have a specific orientation that differs from platform to platform. This means that for many new seat platforms, a new air condition system must be designed, tooled, and tested, which may increase cost and development time.

Accordingly, it may be desirable to have an air conditioning system that can be used across a variety of vehicle seat platforms and can accommodate seat cushion vent holes having various sizes, shapes, or patterns and in in a variety of locations and orientations. This may advantageously reduce costs, development time, and the number of different part numbers a vehicle seat assembler must have on hand. Having such an air conditioning system may also reduce operator training time for installing and/or servicing vehicle seat air conditioning systems.

### SUMMARY

These teachings provide an air conditioning system for a vehicle seat that can be used across a variety of vehicle seat platforms, regardless of the vehicle seat design and/or the size, shape, and/or locations of the seat cushion vent holes. Advantageously, by providing an air conditioning system that can be used in multiple vehicle seat platforms, product development cost and timing may be reduced and/or operator training time for installing and/or servicing air conditioning systems may be reduced. Furthermore, manufacturing and/or assembly tolerances may be enlarged. Numerous other benefits may be realized at the engineering and development centers and/or vehicle seat assembly locations, by having an air conditioning system according to these teachings.

These teachings provide an air conditioning system that may have an air distributor with a top layer, an opposing bottom layer, and a spacer layer in between the top layer and the bottom layer. The top layer and the bottom layer are connected together at a connection area. The top layer has a first strip that defines an opening or ventilation aperture in the top layer through which the spacer layer is exposed. The air conditioning system has an air mover connected to or in fluid communication with the air distributor.

### BRIEF DESCRIPTION OF THE DRAWINGS

FIG. 1 is a side view of a vehicle and a vehicle seat.

FIG. 2A is a perspective view of a seat portion of a vehicle seat.

FIG. 2B is an exploded view of FIG. 2A.

FIG. 3A is a top perspective view of an air distributor.

FIG. 3B is a bottom perspective view of an air distributor.

FIG. 4A is a front view of an air distributor.

FIG. 4B is a cross sectional view of FIG. 4A, taken along line 4B-4B.

FIG. 5 is an exploded, perspective view of the air distributor.

### DETAILED DESCRIPTION

These teachings relative to an air conditioning system for a vehicle or vehicle seat. The vehicle may be an automobile, like a passenger car or truck. The vehicle may be an airplane, train, bus, and/or a boat. However, the vehicle seat may also be used in non-vehicular applications, like in a home or office.

The air conditioning system may be provided in or within one or more portions of the seat, like a bottom or seating portion, a back or back rest portion, a head rest portion, one or more arm rests, one or more bolsters, or a combination thereof. The air conditioning system may be connected, attached, or assembled to the seat, the bottom or seating portion, a back or back rest portion, a head rest portion, one or more arm rests, a seat support, a frame, a cushion, a connecting member, a suspension system, or a combination thereof with one or more fasteners, like pins, push pins, screws, tape, double sided tape, hook and loop fasteners, hangers, metal or plastic brackets, ties, or a combination thereof.

The air conditioning system may function to blow, exhaust, or direct air towards the cushion, an occupant or load in the cushion or vehicle seat, or both. The air conditioning system may function to suck or remove air away from the cushion, an occupant or load in the cushion or vehicle seat, or both. The air conditioning system may function to supply conditioned air towards the cushion, or occupant, or load in the seat. The conditioned air may be warm air (air having a temperature above ambient), cold air (air having a temperature below ambient), or ambient air. The air conditioning system may have one or more air conditioners for raising or lowering a temperature of the air expelled from the air distribution system.

The air conditioning system may include one or more air distributors. An air distributor may function to distribute or spread air that is supplied by one or more air movers when operating in a push mode (i.e., when air is pushed or blown out or towards an occupant in the seat). The pushed air may be distributed or spread to one or more locations of the seat or portions thereof. The air distributor may function to pull, suck, draw, or collect air from one or more locations of the seat or portions thereof by the air mover when the air mover is operating in a pull or suck mode (i.e., when air is being sucked or drawn away from an occupant in the seat).

The air distributor may be comprised of one or more sheets or layers. The air distributor may have a top sheet or layer that is connected to a bottom sheet or layer. The sheets may be connected or sealed at their peripheries or edges to form an open space therein or therebetween. The seal may extend at least partially or entirely around the entire periphery or perimeter of the air distributor. The seal or connection may be a heat seal, RF seal, adhesive, weld, or other air impermeable seal. In some configuration, an air permeable seal may be sufficient around a portion or an entirety of the periphery or perimeter, for example by sewing, stitching or other fastening means. The air distributor may be a bag or have a bag structure. One or more other layers, such as a spacer layer, may be provided within the bag or bag structure, formed by the joining together of the top and bottom sheets.

The top and bottom sheets may also be referred to as upper and lower sheets, top and bottom layers, top and bottom sheets. The top and bottom sheets may be sufficiently air impermeable, such that air is restricted or prevented from passing through the sheets. The top sheet may be sufficiently air impermeable except for the location where the one or more openings or ventilation apertures are located or defined in the top sheet through which air is directed into and/or expelled out of the air distributor. The bottom sheet may be sufficiently air impermeable except for the location where the one or more openings or apertures are located or defined in the bottom sheet for connecting to the air mover.

One or both of the sheets may be sufficiently flexible so that the air distributor can adapt to movement of the seat and/or components thereof when an occupant or load is in the seat. One or both of the sheets may be sufficiently flexible so that the air distributor can adapt to various geometry of the seat and/or seat components to which the air distributor is attached, in contact with, and/or adjacent to. One or both of the sheets may be sufficiently strong to resist puncturing or tearing. One or more both of the sheets may be sufficiently rigid to maintain structure of the air distributor and/or to restrict or prevent bucking or collapse of the air distributor, which may restrict or prevent air from passing therethrough.

One or both of the top and bottom sheets may be comprised of a woven material. One or both of the top and bottom sheets may be comprised of a plastic, polyurethane (PU), or urethane material. The woven material may be coated or covered by the plastic, polyurethane, urethane material, or other film material to achieve the air impermeable characteristics. The film material may have a thickness of about 0.1 mm to about 2.0 mm thick and more preferably about 0.7 mm to about 1.0 mm thick. Of course, it is contemplated that the film may have a variable thickness and may be outside of the aforementioned ranges.

The air distributor may be of the type disclosed in U.S. Pat. No. 6,869,140 B2, the entire disclosure of which is hereby incorporated by reference herein for all purposes.

The top layer or the bottom layer may comprise one or more strips. The one or more strips may function to define an opening or aperture through which one or more connectors or devices, or air may be provided. The one or more strips, referred to as the first strip or first perimeter strip and the second strip or second perimeter strip in the description of the figures, may outline or surround the one or more apertures, through holes, or other openings. The one or more perimeter strips may have a constant width or thickness surrounding the opening or aperture. In other configurations, the one or more strips may have a width or thickness that varies or changes in regions around the one or more apertures or through holes.

The air conditioning system may have one or more spacer layers. The spacer layer may function to prevent crushing and/or collapse of the open space defined between the top and bottom sheets when an occupant and/or load are in the seat, which may undesirably result in air not being able to be moved through the air distributor.

The spacer layer may be a spacer mesh. The spacer layer may be a porous material, a reticulated foam, or any suitable air permeable support. The spacer layer may be a material is sold under the tradename 3MESH® and is commercially available from Müller Textil GmbH, Germany or Müller Textiles, Inc., Rhode Island, USA.

The spacer layer may be connected to the top layer and/or the bottom layer via a suitable fastener or connecting method such as laminating, sewing, stitching, welding, RF welding, hook and loop fasteners, pins, snaps, heat staking, and the like. The spacer layer may be free of any fasteners for connections to the top and/or bottom layer. The top layer and the bottom layer may form an envelope around the edges or periphery of the spacer layer and the spacer layer may be located in between.

The top and bottom layers may be joined together with a suitable fastener and/or connecting method, such as by laminating. Other fasteners and/or method's for joining the top and bottom layers may include sewing, stitching, welding, RF welding, hook and loop fasteners, pins, snaps, heat staking, and the like. The spacer layer may be sandwiched between the top and bottom layers in the connection area and may thus be joined to either or both of the top and bottom layers. The spacer layer may be free from being sandwiched between the top and bottom layers in the connection area and the connection area joining together the top and bottom layers may instead be around an outer perimeter or portion of the spacer layer.

The seat and/or the air conditioning system may include one or more air movers. The one or more air movers may function to move air. The air mover may push, blow, or exhaust air. The air mover may pull, suck, suction, or draw in air. The air may be moved towards or away from the seat, towards or away from an occupant in the vehicle seat, or both. The one or more air movers may move, push, or blow air towards an occupant in the seat. The one or more air movers may move, pull, suck, suction, or draw air away from an occupant in the seat. The air may be ambient air having a generally similar temperature to the air surrounding the seat. The air may be conditioned air. Conditioned air may be air that is generally warmer relative to the surrounding, ambient air. Conditioned air may be air that is generally cooler relative to the surrounding, ambient air. The air mover may be an axial fan, a radial fan, or both.

The one or more air movers may be connected to the air distributor. The one or more air movers may be in fluid communication with the air distributor so that air can be pushed or passed from the air mover to the air distributor and/or pulled or passed from the air distributor to the air mover. In some configurations, one or more seals, ducts, channels, pipes, passages, gaskets, or the like may be provided between the one or more air movers and the air distributor. In some configurations, the air mover may be directly connected to the air distributor and/or partially received in the air distributor to ensure a fluid communication therebetween with little or no loss and reduced packing space.

The one or more air movers may include a thermoelectric device (TED). The TED may heat or warm air as it enters the air mover or as it leaves the air mover. The TED may cool air as the air enters the air mover or as the air leaves the air mover. The TED may be used to heat air and/or cool air that is blown onto the user. The one or more air movers may include a heating device, a cooling device, or both (i.e., a thermoelectric device (TED)). For example, the TED and/or air mover may be used in any manner or any configuration with an insert described in any of U.S. Pat. Nos. RE 38,128; 4,923,248; 6,629,724; 6,676,207; 6,857,697; 6,869,139; 6,869,140; 6,976,734; 7,083,227; 7,213,876; 7,338,117; 7,356,912; 7,475,938; 7,506,938; and 7,587,901 or U.S. Patent Application Publication No. 2009-0218855 the teachings of which are expressly incorporated by reference herein for all purposes.

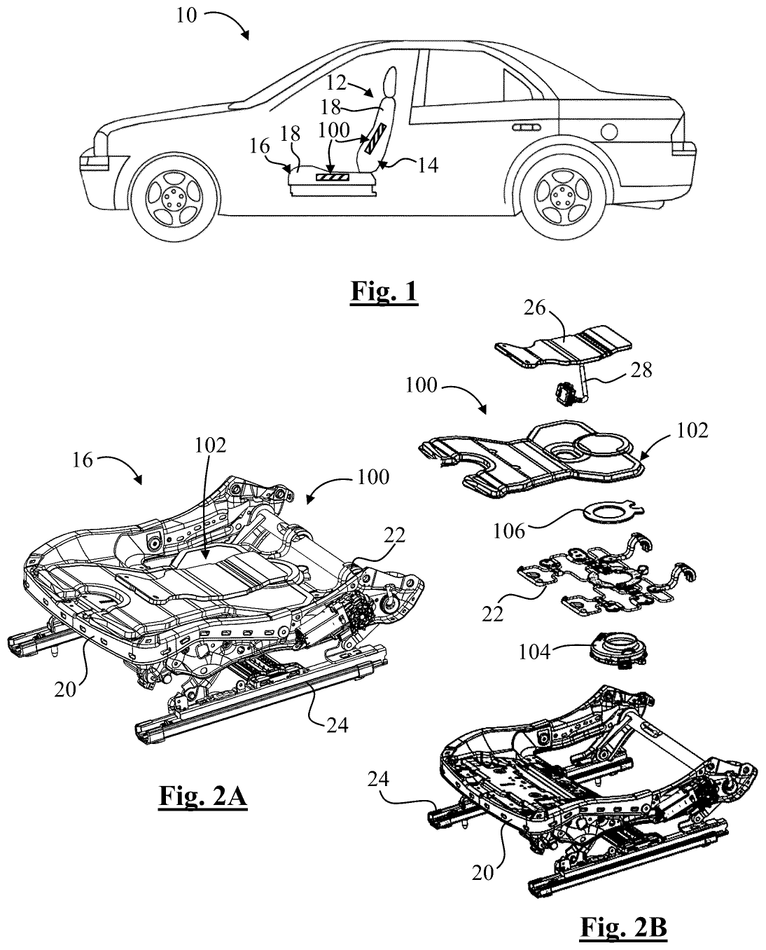

FIG. 1 illustrates a vehicle 10. The vehicle 10 comprises one or more vehicle seats 12. The one or more vehicle seats 12 may each include a back portion 14 and/or a seat portion 16. The back portion 14 and/or a seat portion 16 may include a seat cushion 18. In some configurations, the back portion 14 and/or the seat portion 16 may include more than one seat cushion 18. In some configurations, the back portion 14 and the seat portion 16 may share a common seat cushion 18.

The vehicle seat 12, the back portion 14, and/or the seat portion 16 may include one or more air conditioning systems 100. While the following figures illustrate an air conditioning system in the seat portion 16 of the vehicle seat 12, it is understood that the air conditioning system 100 can be additionally, or instead, located in the back portion 14 of the vehicle seat 12.

FIGS. 2A and 2B illustrate a seat portion 16 of a vehicle seat. The seat portion 16 comprises a cushion frame 20 and a seat suspension 22 that supports the seat cushion 18 (FIG. 1), which has been removed from these figures for clarity. The cushion frame 20 is supported on a seat track 24, which his attached to the vehicle. The air conditioning system 100 may be supported or located on the cushion frame 20, seat suspension, and/or floor of the vehicle. The air conditioning system 100 may be at least partially located below the seat cushion or within a thickness of the seat cushion material.

The air conditioning system 100 comprises one or more air distributors 102 and one or more air movers 104. A connector 106 may be located between the air distributor 102 and the air mover 104. The connector 106 may be used to join together and/or maintain a fluid connection between the air distributor 102 and the air mover 104. The connector 106 may reduce or prevent air leakage between the air distributor 102 and the air mover 104. The connector 106 may reduce or prevent noise, vibration, and harshness (NVH) between the air distributor 102 and air mover 104. In other words, the connector 106 may absorb some vibrations from the air mover 104. The connector 106 may be of the type disclosed in commonly owned U.S. Provisional Application 63/074,502, filed on Sep. 4, 2020, the entirety of which is expressly incorporated by reference herein for all purposes. The connector 106 may be referred to as the gasket in the aforementioned U.S. Provisional application. in some configurations, the connector 106 may be a duct, passageway, pipe, seal, or other member for establishing a fluid connection between the air distributor 102 and the air mover 104 to restrict or prevent air leakage therebetween while air is passed between the air mover 104 and the air distributor.

The vehicle seat 12 may include one or more occupant sensors 26 for sensing presence (or absence) of an occupant or object in the vehicle seat 12. The occupant sensor 26 may include a cable, electronics, connector, or device 28 for connecting the occupant sensor 26 to a vehicle seat controller and/or vehicle controller or computer. The one or more occupant sensors 26 may be in electronic communication with the air conditioning system 100, the one or more air movers 104, the vehicle computer, or a combination thereof. The one or more occupant sensors 26 may provide signals to turn ON and/or to turn OFF the air conditioning system 100 and/or the one or more air movers 104 depending on if there is an occupant and/or object in the vehicle seat or not.

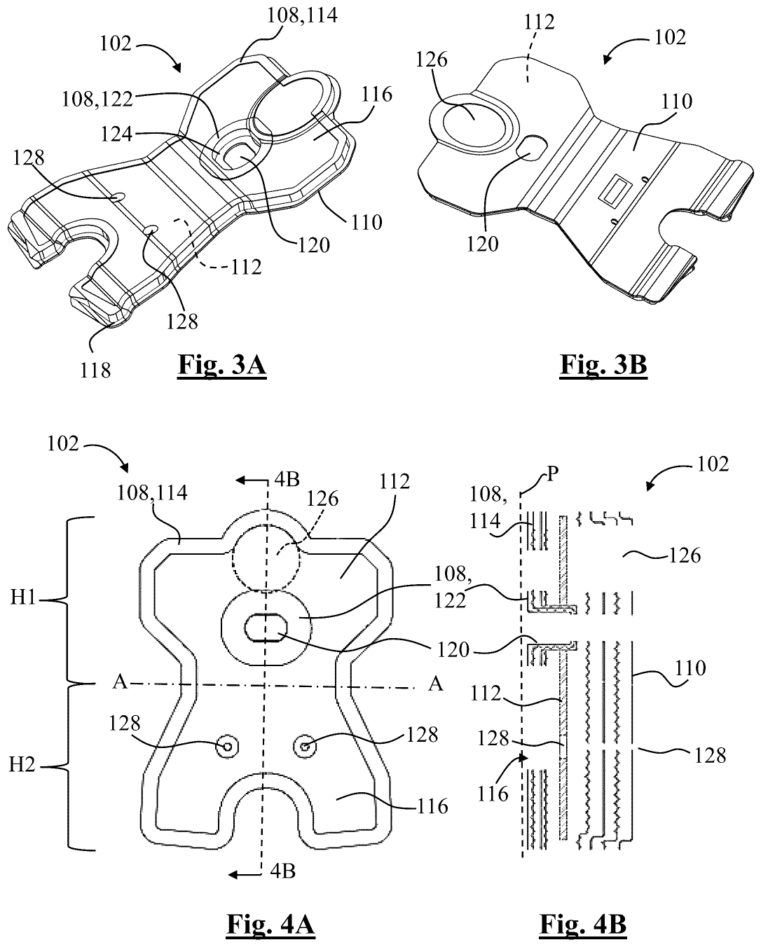

FIGS. 3A, 3B, 4A, 4B, and 5 illustrate an air distributor 102. The air distributor 102 comprises a top layer 108, an opposing bottom layer 110, and a spacer layer 112 in between the top layer 108 and the bottom layer 110.

The top layer 108 may be formed of one or more layers or materials. The one or more layers or material may be air impermeable. For example, the top layer 108 may be made of a fleece material and a film, such as a polyurethane (PU) film. The bottom layer 110 may be formed of one or more layers or materials that are also air impermeable. The bottom layer 110 may be made of the same materials as the top layer 108, or the bottom layer 110 may be made of different materials as the top layer 108. The spacer layer 112 may be formed of one or more layers or materials that are preferably air permeable. The spacer layer 112 may function to maintain a gap or spacing between the top and bottom layers 108, 110. The spacer layer 112 may function to restrict or prevent the spacing between the top and bottom layers 108, 110 from collapsing or being crushed, when an object or occupant is in the vehicle seat. The spacer layer 112 may be sandwiched between the layers 108, 110. The top and bottom layers 108, 110 may at least partially, or entirely, surround the spacer layer 112. The top and bottom layers 108, 110 may be a bag or bag structure that houses or encapsulates the spacer layer 112.

The top layer 108 may comprise a first strip 114. The top layer 108 may be the first strip 114. The first strip may extend around a perimeter or periphery of the spacer layer 112. The first strip 114 may extend along or around a perimeter of the air distributor 102 and/or at a periphery or edge of the air distributor 102. The first strip 114 may be referred to as a perimeter strip 114 or a first perimeter strip. In other words, the top layer 108 or first strip 114 may extend along a single plane (i.e., at the top surface of the air distributor). The top layer 108 or first strip 114 may additionally, or instead, extend along a second plane at the side edges or periphery of the air distributor 102 that is at an angle or generally perpendicular to the top surface of the air distributor 102.

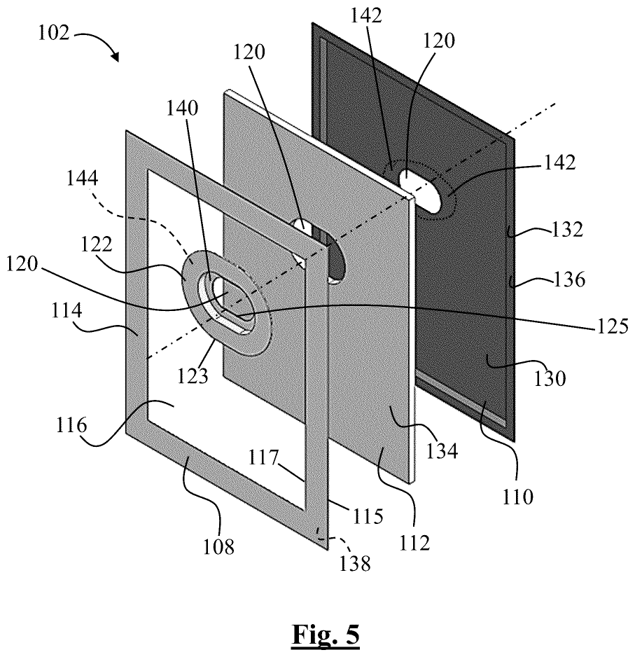

As perhaps better understood by referring to the schematic air distributor 102 illustrated in FIG. 5, the first strip 114 or first perimeter strip 114 may be a rim, frame, border, or picture frame. The first strip 114 or perimeter strip 114 may define or extend around an opening or ventilation aperture 116. The first strip 114 may have a width or thickness that extends from an outer edge or periphery 115 to an inner edge or periphery 117. The width or thickness may be constant around a perimeter of the top layer 108 or air distributor 102. The width or thickness may vary or change around a perimeter of the top layer 108 or air distributor 102.

The opening or ventilation aperture 116 may be defined by or within the inner edge or periphery 117 of the first strip 114. The opening or ventilation aperture 116 may be an absence of material within the border of the first strip 114. The absence of material 116 or ventilation aperture may be in the same horizontal plane P (FIG. 4B) as the first perimeter strip and/or the second perimeter strip. The first and second perimeter strips may be located in the same plane P or same horizontal plane. In some configurations, this absence of material may be covered by an air permeable sheet or foil, such as a screen. The spacer layer 112 may be visible or exposed through the opening or ventilation aperture 116. That is, when looking down onto or into the first strip 114 or top layer 108, the spacer layer 112 is visible or exposed through the opening or ventilation aperture 116. In other words, the spacer layer 112 can be touched or contacted through the ventilation aperture 116.

The size and shape of the opening or ventilation aperture 116 may be virtually any size or shape, depending on the size, shape, and orientation of the first strip 114.

The first strip 114 may have a width that is substantially constant or consistent, along or around a perimeter of the ventilation aperture 116. In other words, in some configurations, a width of the first strip 114 does not vary or change around the air distributor 102. In some configurations, the first strip 114 may also extend between the lateral or longitudinal members defining the first strip 114. That is, FIG. 5 shows the first strip 114 as having a rectangular shape defined by opposing vertical and horizontal members. The first strip 114 may have additional strips that extend between the opposing horizontal and/or vertical members. The first strip 114 need not be exclusively a rectangular shape, as clearly shown in the preceding FIGS. 3A-4A.

Referring to the previous figures, the top layer 108 and/or the first strip 114 may be connected or joined to the bottom layer 108 at a first connection area 118. The first connection area 118 may be arranged closer to the top layer 108 than the bottom layer 110, or closer to the bottom layer 110 than the top layer 108 as illustrated in FIG. 3A. The first connection area 118 may be located in between the top and bottom layers 108, 110. The first connection area 118 may extend outwardly away from the side edges of the air distributor 102. The first strip 114 and/or the edge 115 may be connected to the bottom layer or flange region 132. In some configurations, the first strip 114 may have a flange region instead of, or like, the flange region 132 in the bottom layer 110.

The top and bottom layers 108, 110 may be joined together at the first connection area 118 with a suitable fastener and/or connecting method. For example, the connecting method may include laminating, sealing, heat sealing, using one or more adhesives, tapes, double sided tape, pressure sensitive tape, double sided tape, sewing, welding, RF welding, etc. The top layer 108 and/or the first strip 114 may be connected or joined to the spacer layer 112. The top layer 108 and/or the first strip 114 may be connected to the spacer layer 112 with a suitable fastener and/or connecting method, such as any of the method or types disclosed herein. The top layer and the bottom layer may contact and sandwich the spacer layer together in the connecting area 118. However, in some configurations, the spacer layer may be free from any attachment to the top and/or bottom layers in the connection area. Preferably, the connection is such that an air permeable seal is formed between the

The air distributor 102 may include one or more through holes 120. The through hole 120 may extend through or may be defined in one or more layers of the air distributor 102. The through hole 120 may extend through or may be defined in the spacer layer 112, the bottom layer 110, or even the top layer 114 so that a device or instrument of the vehicle and/or the vehicle seat (such as the cable or device 28 for connecting the occupant sensor 26, FIG. 1) can pass through the air distributor 102. The through hole 120 may be aligned with or arranged in the region of the opening or ventilation aperture 116 defined in the top layer 108.

The top layer 108 may comprise a second strip 122. The second strip 112 may extend about, along, or around a perimeter of the through hole 120. The second strip 122 may be a rim, frame, or border around the through hole 120. The second strip 122 may have a width that is substantially constant or consistent, along or around a perimeter of the through hole 120. The second strip 122 may have a width that is irregular or changing around the through hole 120. The second strip 122 may have any size and/or shape so the through hole 120 also has any size or shape. The width of the second strip 122 may be defined between an outer periphery or edge 123 and an inner periphery or edge 125.

The ventilation aperture 116 may extend around the second perimeter strip 122. The ventilation aperture 116 may extend around the second perimeter strip 122 and be contained within the first perimeter strip 114. The ventilation aperture 116 may be located in a region between a width of the first perimeter strip 114 (defined between edges 115, 117) and a width of the second perimeter strip 122 (defined between edges 123, 125).

The top layer 108 and/or the second strip 122 may be connected or joined to the bottom layer 108 at a second connection area 124. Any suitable faster or connecting method disclosed herein may be used. The top layer 108 and/or the second strip 122 may be connected to the spacer layer 112 with any connecting method or fastener disclosed herein. The second strip 122 may be referred to as a perimeter strip or a second perimeter strip 122. The through hole 120 may have any shape and there may be more than one through hole 120 in some configurations.

The first strip 114 and the second strip 122 may be separate, discrete, individual pieces that are free of any connection to one another. That is, other than being indirectly connected to one another via the connection of the first and second strips 114, 122 to the spacer layer 112 and/or the bottom layer 110, the first and second strips 114, 122 may be free from being directly connected or joined to one another or contacting one another. However, in some configurations, the first and second strips 114, 122 may be directly connected to one another (i.e., via another strip or via one or both of the strips 114, 122 extended or reconfigured to make the connection), for example, depending on seat geometry, integrity of the top layer 108, and/or for manufacturing or assembly purposes. In other words, a portion of the first strip 114 may extend and connect to the second strip 122 in one or more regions and/or a portion of the second strip 122 may extend and connect to the first strip 114 in one or more regions. Such connections may assist in the manufacturing or assembly of the device.

The bottom layer 110 may comprise one or more apertures 126. The aperture 126 may connect with the air mover 104 directly or indirectly, such as via a connector 106, to connect the air mover 104 to the air distributor 102. The aperture 126 may cooperate with the air mover 104 (FIG. 2B) to provide an inlet and/or outlet for air to enter the air distributor 102 and/or to be removed from the air distributor 104. In some configurations, more than one air mover may be connected to the bottom layer.

The bottom layer 110 may be connected to the spacer layer 112 with a suitable fastener and/or connecting method disclosed herein, such as by laminating, welding, RF welding, heat welding, adhesive, etc. the connection may be air impermeable or air permeable.

An axis A-A extending across a width of the air distributor 102 may divide a length of the air distributor 102 into two generally equal halves H1 and H2. Both of the aperture 126 and the through hole 120 may be arranged in one H2 of the two generally equal halves H1, H2. However, it may be envisioned that in some configurations the aperture 126 and the through hole 120 may be located in different halves H1, H2, or in the other half H2, depending on seat geometry for example.

As shown, a central axis of the aperture 126 is offset from a central axis of the through hole 120 (the referred to central axis extends out of the page). However, in some configurations, the two axes may be aligned. The two axes are illustrated as aligned along the plane or section line 4B-4B, which extends along a center of the distributor 102. However, in some configurations, the two axes may be offset from one another relative to the plane or line 4B.

The air distributor 102 comprises one or more attachment apertures 128 (two are illustrated). Fasteners may extend through the one or more attachment apertures 128 to connect or fasten the air conditioning system 100, the air distributor 102, or both to the seat suspension 22, the seat frame 20, the cushion 18, or a combination thereof. The fasteners may also extend through corresponding attachment apertures in the occupant sensor 26 or other devices of the seat. The attachment apparatus 128 may be arranged in the other half H2 of the air distributor 102, that does not include the aperture 126 and the through hole 120. However, it may be envisioned that in some configurations attachment apparatus 128 may be located in the same half H1 as one or both of the aperture 126 and through hole 120, depending on seat geometry and/or assembly conditions, for example.

When the air conditioning system 100 is installed in a vehicle seat 12 (FIG. 1), the top layer 108, the first strip 114, and/or the second strip 122 may be located adjacent to or in contact with the seat cushion 18 or a bottom surface of the seat cushion 18, so that air supplied into or through the air distributor 102 via the air mover 104 can be pushed or blown into or through the seat cushion and/or one or more vent holes defined in the seat cushion and then to the occupant of the vehicle seat. In some configurations, the air conditioning system or the air distributor may be located inside a thickness of the seat cushion or on top of the seat cushion, between the cushion and the top layer or material of the vehicle seat that an occupant is in contact with when seated in the seat. The top layer 108, the first strip 114, and/or the second strip 122 may be attached to the seat cushion 18 with any suitable fastener disclosed herein including, pins, tape, hook and loop fasteners, and the like. In some configurations, the top layer 108, the first strip 114, and/or the second strip 122 may be a tape, double sided tape, pressure sensitive tape, that is configured to be connected to the seat cushion, foam, suspension, or other component of the seat arranged adjacent to the air conditioning system 100 or air distributor.

Alternatively, the top layer 108, the first strip 114, and/or the second strip 122 may be free of attachment with fasteners to the seat cushion 18.

During use, air may be blown or pushed into the air distributor 102 through the aperture 126 defined in the bottom layer 110 with the air mover 104. The air may travel through the air permeable spacer layer 112 and exit the air distributor 102 via the opening or ventilation aperture 116 defined in the top layer 108. Because the ventilation aperture 116 is rather large, the air exiting the or ventilation aperture 116 will be blown into the one or more vent holes in the seat cushion 18 which will ultimately be towards or at an occupant in the vehicle seat 12. Advantageously, by having the large opening or ventilation aperture 116, placement or location or alignment of the vent holes in the seat cushion 18 with the opening or ventilation aperture 116 is generally irrelevant since the ventilation aperture 116 is much larger than any single seat cushion vent hole, which makes the air distributor 102 and the system 100 according to these teachings flexible and readily available for implementation into a variety of vehicle seat platforms and/or cushion designs where the vent holes are in various locations, due to design constraints, such as seat trench locations.

FIG. 5 illustrates the air distributor 102. The bottom layer 110 has a recessed region 130 that may be sized to accommodate the spacer layer 112. The depth of the recessed region 130 may be approximately the same size as a thickness of the spacer layer 134. This may allow for the top layer or the first perimeter strip to lay flat or be in planar contact with the top surface 136 of the flanged region 132, which may aid in connecting or sealing the top layer and the bottom layer. Alternately, the recessed region may have a depth that is less than a thickness of the spacer layer 112. Alternately, the recessed region may have a depth that is greater than a thickness of the spacer layer 112.

The bottom layer 110 has a flange region 132 surrounding the recessed region 130. The flange region 132 may be above the recessed region 132 or in a different plane than the recessed region 132. After the spacer layer 112 is received into and/or seated within the recessed region 130, a top surface 134 of the spacer layer 112 may be generally flush with a top surface 136 of the flange region 132. In other configurations, the top surface 134 of the spacer layer 112 may be sub flush or below the top surface 136 of the flange region 132. In other configurations, the top surface 134 of the spacer layer 112 may be proud or above the top surface 136 of the flange region 132.

The back side 138 of the top layer 108 or first strip 114 may be sealed, laminated, or otherwise attached to the top surface 136 of the flange region 132, thereby sandwiching the spacer layer 112 in between. In some configurations, the spacer layer 112 may be provided between the top surface 132 of the flange region 136 and the back side 138 of the top layer 108 and attached to both layers 110, 108 during the attaching, laminating, or welding process. In the regions where the first strip 114 or the second strip 122 are located, the device may be air impermeable if the first strip 114 and/or second strip 122 are made from an air impermeable material or if the connecting method functions to close any pores in the first or second strip 114 122, such as during heating or welding. However, it is envisioned that improvements can be made to obtain a secure connection, while still providing an air permeable connection.

The second strip 122 or second perimeter strip 122 that surrounds the through hole 120 in the top layer 108 has a flanged region 140. The flanged region 140 may be recessed or stepped below the rest of the second strip 122. The flanged region 140 is configured to fit within the through hole 120 and attach to the recessed region 130 around the through hole 120 in the bottom layer 110. The flanged region 138 of the second strip 122 may be attached, laminated, welded or secured to a region 142 of the recessed region 130 defined around the through hole 120.

The back side 144 of the second strip 122 of the top layer 108 may be attached (laminated, welded, adhesive, etc.) to the spacer layer 112. Or the back side 144 of the second strip 122 of the top layer 108 may be free of any attachment to the spacer layer 112. Instead, the back side 144 may merely be in contact with the spacer layer 112 or there may be a gap therebetween.

The explanations and illustrations presented herein are intended to acquaint others skilled in the art with the invention, its principles, and its practical application. The above description is intended to be illustrative and not restrictive. Those skilled in the art may adapt and apply the invention in its numerous forms, as may be best suited to the requirements of a particular use.

Accordingly, the specific embodiments of the present invention as set forth are not intended as being exhaustive or limiting of the teachings. The scope of the teachings should, therefore, be determined not with reference to this description, but should instead be determined with reference to the appended claims, along with the full scope of equivalents to which such claims are entitled. The omission in the following claims of any aspect of subject matter that is disclosed herein is not a disclaimer of such subject matter, nor should it be regarded that the inventors did not consider such subject matter to be part of the disclosed inventive subject matter.

Plural elements or steps can be provided by a single integrated element or step. Alternatively, a single element or step might be divided into separate plural elements or steps.

The disclosure of “a” or “one” to describe an element or step is not intended to foreclose additional elements or steps. For example, disclosure of “a motor” does not limit the teachings to a single motor. Instead, for example, disclosure of “a motor” may include “one or more motors.”

While the terms first, second, third, etc., may be used herein to describe various elements, components, regions, layers and/or sections, these elements, components, regions, layers and/or sections should not be limited by these terms. These terms may be used to distinguish one element, component, region, layer or section from another region, layer, or section. Terms such as “first,” “second,” and other numerical terms when used herein do not imply a sequence or order unless clearly indicated by the context. Thus, a first element, component, region, layer, or section discussed below could be termed a second element, component, region, layer, or section without departing from the teachings.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below”, or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

The invention illustratively disclosed herein suitably may be practiced in the absence of any element which is not specifically disclosed herein.

Any of the elements, components, regions, layers and/or sections disclosed herein are not necessarily limited to a single embodiment. Instead, any of the elements, components, regions, layers and/or sections disclosed herein may be substituted, combined, and/or modified with any of the elements, components, regions, layers and/or sections disclosed herein to form one or more embodiments that may not be specifically illustrated or described herein.

The disclosures of all articles and references, including patent applications and publications, testing specifications, are incorporated by reference for all purposes. Other combinations are also possible as will be gleaned from the following claims, which are also hereby incorporated by reference into this written description.

1. An air conditioning system for a vehicle seat, comprising:
an air mover; and
an air distributor in fluid communication with the air mover, the air distributor comprises a top layer, a bottom layer, and a spacer layer between the top layer and the bottom layer;
wherein the top layer comprises a first perimeter strip that extends around a perimeter of the air distributor and around a ventilation aperture defined in the top layer, and the first perimeter strip is sealed to the bottom layer around the perimeter of the air distributor.

2. The air conditioning system according to claim 1, wherein the seal is a heat seal or an RF weld.

3. The air conditioning system according to claim 1, wherein top layer comprises a second perimeter strip that surrounds a through hole.

4. The air conditioning system according to claim 3, wherein the first perimeter strip and the second perimeter strip are discrete members that are not connected to one another.

5. The air conditioning system according to claim 4, wherein a through hole extends through the spacer layer and the bottom layer.

6. The air conditioning system according to claim 5, wherein the second perimeter strip comprises a region that extends through the through hole in the spacer layer to connect to the bottom layer.

7. The air conditioning system according to claim 6, wherein the second perimeter strip comprises a width and the first perimeter strip comprises a width, and at least a portion of the ventilation aperture is defined between the width of the first perimeter stirp and the second perimeter strip.

8. The air conditioning system according to claim 7, wherein the bottom layer comprises an aperture for the air mover to provide air into the air distributor or for removing air from the air distributor.

9. The air conditioning system according to claim 8, wherein the air distributor comprises an axis divides a length of the air distributor into two generally equal halves, and both of the aperture and the through hole are arranged in one of the two generally equal halves.

10. The air conditioning system according to claim 7, wherein the ventilation aperture is located in a region between a width of the first perimeter strip and a width of the second perimeter strip.

11. The air conditioning system according to claim 10, wherein the air distributor comprises one or more attachment apertures that are arranged in the other of the two generally equal halves.

12. The air conditioning system according to claim 1, wherein the top layer and/or the bottom layer comprise an air impermeable material and the spacer layer comprises an air permeable material.

13. The air conditioning system according to claim 1, wherein the bottom layer comprises a recessed region having a depth that is approximately the same as a thickness of the spacer layer.

14. An air conditioning system for a vehicle seat, comprising:
an air mover; and
an air distributor in fluid communication with the air mover, the air distributor comprises a top layer, a bottom layer, and a spacer layer between the top layer and the bottom layer;
wherein the top layer comprises:
i) a first perimeter strip that extends around a perimeter of the air distributor, the first perimeter strip extends around a ventilation aperture defined in the top layer and is sealed to the bottom layer; and
ii) a second perimeter strip that extends around a through hole defined in the top layer, the spacer layer, and the bottom layer,
wherein the second perimeter strip extends through the through hole in the spacer layer and is connected to the bottom layer.

15. The air conditioning system according to claim 14, wherein the ventilation aperture is an absence of material in the top layer defined between the first perimeter strip and the second perimeter strip, and
wherein the first perimeter strip and the second perimeter strip are discrete members that are not connected to one another

16. The air conditioning system according to claim 14, wherein the bottom layer comprises an aperture for the air mover to provide air into the air distributor or for removing air from the air distributor, the aperture being discrete from the through hole.

17. The air conditioning system according to claim 14, wherein the air distributor comprises an axis divides a length of the air distributor into two generally equal halves, and both of the aperture and the through hole are arranged in one of the two generally equal halves.

18. The air conditioning system according to claim 14, wherein the ventilation aperture is located in a region between a width of the first perimeter strip and a width of the second perimeter strip, and the first perimeter strip and the second perimeter strip are both heat sealed to the bottom layer.

19. The air conditioning system according to claim 14, wherein the second perimeter strip comprises a flanged area that extends through the through hole in the spacer layer and is connected to the bottom layer and/or wherein the bottom layer comprises a recessed region having a depth that is approximately the same as a thickness of the spacer layer.

20. (canceled)

21. The air conditioning system according to claim 1, wherein the air conditioning system is free of any mechanical fasteners for connecting the first perimeter strip to the bottom layer in a region where the first perimeter strip is sealed to the bottom layer around the perimeter of the air distributor.
